(19) United States
(12) Patent Application Publication
(10) Pub. No.: US 2021/0108054 A1
(43) Pub. Date: Apr. 15, 2021

(54) POLYMER BLENDS AND PRODUCTS FORMED FROM SAME

(71) Applicants: Dow Global Technologies LLC, Midland, MI (US); Dow Silicones Corporation, Midland, MI (US)

(72) Inventors: Andong Liu, Shanghai (CN); Fengyi Su, Shanghai (CN); Hongyu Chen, Shanghai (CN); Jianping Pan, Shanghai (CN); Xiaobing Yun, Shanghai (CN); Thomas Allgeuer, Wollerau (CH); Di Xu, Beijing (CN); Yuguo Ma, Beijing (CN)

(21) Appl. No.: 16/970,475

(22) PCT Filed: Mar. 15, 2018
(86) PCT No.: PCT/CN2018/079078

§ 371 Date: Aug. 17, 2020

(51) Int. Cl. C08L 23/06

(52) U.S. Cl. CPC C08L 23/06

(57) ABSTRACT

Provided is a polymer blend that can be used in films, packages, and fibers. In one aspect, a polymer blend comprises an ethylene-based polymer, and one or more compounds of formula (I), wherein n is 6 to 24.

### FIELD

The present invention relates to polymer blends that can be used in films, packages, and fibers.

### INTRODUCTION

Polyethylenes are useful polymers because they provide a variety of beneficial properties such as weight, durability, processability, and cost. However, adhesion of polyethylenes to certain materials can be difficult because of their low polarity and low surface energy. This can be a drawback in certain applications such as lamination, painting, and printing which typically desire a surface energy above 38 dynes. To improve the hydrophilicity and the adhesive properties of polyethylene films, various techniques have been applied to modify the surface energy of the film surface, such as flame treatment, plasma treatment, physical or chemical treatment, grafting, application of a primer, corona treatment, and additive blending.

Corona treatment is widely used for polyethylene films. It not only enables a continuous adjustment of the polyethylene surface during processing, but can also be performed quickly. Nevertheless, modification of the polyethylene surface by corona treatment can be easily destroyed in a variety of ways including, for example, due thermodynamically driven forces in the course of aging. In other words, the increase in surface energy provided by corona treatment of polyethylene can decay naturally over time.

It would thus be desirable to have polyethylene films and other structures that have stable surface energy after corona treatment.

### SUMMARY

The present invention provides polymer blends for use in polyethylene films that advantageously provide stable surface energy in films after corona treatment. The films can have stable surface energy, in some embodiments, for an extended period of time so as to avoid the need for a second corona treatment or other action to increase the surface energy. Such stable and sufficiently high surface energy can help to enhance the printing quality of polyethylene films and/or bonding strength to adhesives in some embodiments. The polymer blends, in some embodiments, can also be used in products other than films such as fibers.

In one aspect, the present invention provides a polymer blend that comprises an ethylene-based polymer, and one or more compounds of Formula (I):

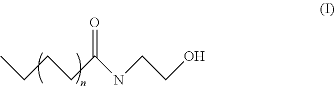

wherein n is 6 to 24. In some embodiments, n is 6 to 16. In some embodiments, n is 12 to 24.

Embodiments of the present invention also provide films comprising a layer comprising a polymer blend according to any of the embodiments disclosed herein, packages formed from such films, fibers comprising a polymer blend according to any of the embodiments disclosed herein, as well as woven and nonwoven substrates comprising such fibers.

These and other embodiments are described in more detail in the Detailed Description.

### BRIEF DESCRIPTION OF THE DRAWINGS

FIG. 1 shows the results of surface energy measurements over time for films according to some embodiments of the present invention and a comparative film.

### DETAILED DESCRIPTION

Unless specified otherwise herein, percentages are weight percentages (wt %) and temperatures are in ° C.

The term “composition,” as used herein, includes material(s) which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities may be incorporated into and/or within the polymer.

The term “interpolymer,” as used herein, refers to a polymer prepared by the polymerization of at least two different types of monomers. The generic term interpolymer thus includes copolymers (employed to refer to polymers prepared from two different types of monomers), and polymers prepared from more than two different types of monomers. The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.940 g/cm³.

The term “LLDPE”, includes both resin made using the traditional Ziegler-Natta catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art, with gas and slurry phase reactors being most preferred. LLDPEs typically can have a density up to 0.940 g/cm³, and can include ULDPE and VLDPE which are LLDPEs having densities at the lower end of the range.

The term “MDPE” refers to polyethylenes having densities from 0.926 to 0.940 g/cm³. “MDPE” is typically made using chromium or Ziegler-Natta catalysts or using metallocene, constrained geometry, or single site catalysts, and typically have a molecular weight distribution (“MWD”) greater than 2.5.

The term “HDPE” refers to polyethylenes having densities of about 0.940 g/cm³ or greater, which are generally prepared with Ziegler-Natta catalysts, chrome catalysts or even metallocene catalysts.

Unless otherwise indicated herein, the following analytical methods are used in the describing aspects of the present invention:

Melt index: Melt indices I₂ (or I2) and I₁₀ (or I10) are measured in accordance to ASTM D-1238 at 190° C. and at 2.16 kg and 10 kg load, respectively. Their values are reported in g/10 min. “Melt flow rate” is used for polypropylene based resins, and other resins, and determined according to ASTM D1238 (230° C. at 2.16 kg).

Density: Samples for density measurement are prepared according to ASTM D4703. Measurements are made, according to ASTM D792, Method B, within one hour of sample pressing.

Additional properties and test methods are described further herein.

It has been found that by including certain polar additives in a polymer blend with an ethylene-based polymer, the use of such polymers in polyethylene films can result in enhanced printing quality of the polyethylene films and/or improved bonding strength to adhesives in some embodiments. The use of such polar additives can also stabilize the surface energy of a polyethylene film for an extended period of time in some embodiments.

In one aspect, the present invention provides a polymer blend that comprises an ethylene-based polymer, and one or more compounds of Formula (I):

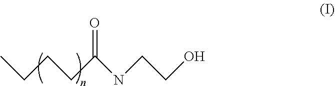

wherein n is 6 to 24. In some embodiments, n is 6 to 16. In some embodiments, n is 12 to 24. The polymer blend, in some embodiments, comprises 0.01 to 5 weight percent of compounds of Formula (I). In some embodiments, the polymer blend comprises a first compound of Formula (I) and a second compound of Formula (I), wherein the value of n for the second compound is different from the value of n for the first compound.

In some embodiments, the polymer blend further comprises at least one polar polymer, polar oligomer, or ionomer wherein the polar polymer, polar oligomer, or ionomer comprises ethylene acrylate copolymer or ionomer thereof, ethylene methyl acrylate copolymer or ionomer thereof, ethylene ethyl acrylate copolymer or ionomer thereof, ethylene butyl acrylate copolymer or ionomer thereof, ethylene acrylic acid copolymer or ionomer thereof, polyethylene glycol, polyethylene-polyethylene glycol, polyethylene-polyethylene glycol-polyethylene, ethylene vinyl acetate copolymer, polyvinyl alcohol, or combinations thereof. In some such embodiments, the polymer blend comprises 5 weight percent or less of polar polymer or polar oligomer based on the total weight of the polymer blend.

Embodiments of the present invention also relate to films. In some embodiments, the present invention provides a film comprising a layer comprising a polymer blend according to any of the embodiments of polymer blends disclosed herein. In some embodiments, the film is a multilayer film comprising an outer layer comprising a polymer blend according to any of the embodiments of polymer blends disclosed herein. In some embodiments, the outer layer of the film comprising the polymer blend is corona treated, and the outer layer exhibits a surface energy of at least 36 dynes/cm² at 60 days following the corona treatment. In some embodiments, the outer layer of the film comprising the polymer blend is corona treated, and the outer layer exhibits a surface energy of at least 36 dynes/cm² at 150 days following the corona treatment. Embodiments of the present invention also relate to packages formed from any of the embodiments of films disclosed herein.

Embodiments of the present invention also relate to fibers. In some embodiments, the present invention provides a fiber comprising a polymer blend according to any of the embodiments of polymer blends disclosed herein. In some embodiments, the present invention provides woven substrates or nonwoven substrates comprising a plurality of such fibers.

Polymer blends of the present invention comprise the compound of Formula (I):

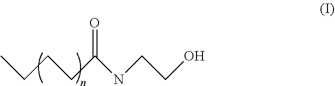

wherein n is 6 to 24. In some embodiments, n is 6 to 16. In some embodiments, n is 12 to 24. In some embodiments, the polymer blend comprises a first compound of Formula (I) and a second compound of Formula (I), wherein the value of n for the second compound is different from the value of n for the first compound.

Without wishing to be bound by any particular theory, the inclusion of the 2-hydroxyethyl amides with different alkyl chain lengths of Formula (I) is believed to provide films having stable surface energy, in some embodiments, for an extended period of time so as to avoid the need for a second corona treatment or other action to increase the surface energy. Such stable and sufficiently high surface energy can also help to enhance the printing quality of polyethylene films and/or bonding strength to adhesives.

Compounds of Formula (I) can be synthesized using long chain, linear primary carboxylic acids as described in the below Examples. Examples of such long chain, linear primary carboxylic acids are UNICID acids which are commercially available from Baker Hughes Incorporated.

The amount of compounds of Formula (I) that can be used in polymer blends of the present invention depends on a number of factors including, for example, the desired properties of the polymer blend, the desired properties of any films to be made from the polymer blend, the desired properties of articles to be made from such films or polymer blends, and/or other factors. The polymer blend, in some embodiments, comprises 0.01 to 5 weight percent of compounds of Formula (I). In some embodiments, the polymer blend comprises 0.05 to 2.0 weight percent of compounds of Formula (I). The polymer blend, in some embodiments, comprises 0.05 to 1.0 weight percent of compounds of Formula (I). In some embodiments, the polymer blend comprises 0.01 to 0.3 weight percent of compounds of Formula (I). The polymer blend, in some embodiments, comprises 0.05 to 0.2 weight percent of compounds of Formula (I).

Polymer blends of the present invention further comprise one or more ethylene-based polymers. A wide variety of ethylene-based polymers can be used depending on a number of factors including, for example, the desired properties of the polymer blend, the desired properties of films to be made from the polymer blend, the desired properties of articles to be made from such films, and/or other factors. A blend of ethylene-based polymers can be used in some embodiments.

In some embodiments, the ethylene-based polymer has a density of 0.870 g/cm³ or more. All individual values and subranges from equal to or greater than 0.870 g/cm³ are included and disclosed herein; for example the density of the ethylene-based polymer can be equal to or greater than 0.870 g/cm³, or in the alternative, equal to or greater than 0.900 g/cm³, or in the alternative, equal to or greater than 0.910 g/cm³, or in the alternative, equal to or greater than 0.915 g/cm³, or in the alternative, equal to or greater than 0.920 g/cm³. The ethylene-based polymer has a density equal or less than 0.970 g/cm³. All individual values and subranges from equal to or less than 0.970 g/cm³ are included and disclosed herein. For example, the density of the polyethylene can be equal to or less than 0.970 g/cm³, or in the alternative, equal to or less than 0.960 g/cm³, or in the alternative, equal to or less than 0.955 g/cm³, or in the alternative, equal to or less than 0.950 g/cm³.

In some embodiments, the ethylene-based polymer has a melt index (I₂) of 20 g/10 minutes or less. All individual values and subranges up to 20 g/10 minutes are included herein and disclosed herein. For example, the ethylene-based polymer can have a melt index from a lower limit of 0.2, 0.25, 0.5, 0.75, 1, 2, 4, 5, 10 or 15 g/10 minutes to an upper limit of 1, 2, 4, 5, 10, or 15 g/10 minutes. The ethylene-based polymer has a melt index (I₂) of up to 15 g/10 minutes in some embodiments. The ethylene-based polymer has a melt index (I₂) of up to 10 g/10 minutes in some embodiments. In some embodiments, the ethylene-based polymer has a melt index (I₂) less than 5 g/10 minutes.

Ethylene-based polymers that are particularly well-suited for use in some embodiments of the present invention include linear low density polyethylene (LLDPE), low density polyethylene (LDPE), high density polyethylene (HDPE), enhanced polyethylene (EPE), and combinations thereof. In some embodiments, the ethylene-based polymer is LLDPE and/or LDPE.

Various commercially available ethylene-based polymers are contemplated for use in polymer blends of the present invention. Examples of commercially available LDPE that can be used in embodiments of the present invention include those available from The Dow Chemical Company under the names DOW LDPE™ and AGILITY™. Examples of commercially available LLDPE that can be used in embodiments of the present invention include DOWLEX™ linear low density polyethylene commercially available from The Dow Chemical Company, such as DOWLEX™ 2038.68G. Examples of commercially available HDPE that can be used in embodiments of the present invention include those available from The Dow Chemical Company under the names DOW™ HDPE resins and DOWLEX™. In addition to HDPE resins, the polyolefin used in the polymer blend can also include enhanced polyethylenes. Examples of commercially available enhanced polyethylene resins that can be used in embodiments of the present invention include ELITE™, ELITE™ AT, and AFFINITY™ enhanced polyethylenes, such as ELITE™ 5400G, which are commercially available from The Dow Chemical Company. Examples of other ethylene-based polymers that can be used in some embodiments of the present invention are INNATE™ polyethylene resins available from The Dow Chemical Company. Persons of skill in the art can select other suitable commercially available ethylene-based polymers for use in polymer blends based on the teachings herein.

The polymer blend comprises up to 99.99 weight percent ethylene-based polymers based on the weight of the blend in some embodiments. In some embodiments, the polymer blend comprises 90 weight percent or more polyethylene based on the weight of the blend in some embodiments. In some embodiments, the polymer blend comprises 95 weight percent or more ethylene-based polymers based on the weight of the blend. The polymer blend, in some embodiments, comprises up to about 95 weight percent ethylene-based polymers based on the weight of the blend. The polymer blend, in some embodiments, comprises up to about 90 weight percent ethylene-based polymers based on the weight of the blend. In some embodiments, the polymer blend comprises up to about 95 weight percent ethylene-based polymers based on the weight of the blend. The polymer blend, in some embodiments, comprises up to about 97 weight percent ethylene-based polymers based on the weight of the blend. In some embodiments, the polymer blend can comprise 90 to 99.99 wt % ethylene-based polymers based on the weight of the blend. All individual values and subranges from 90 to 99.99 wt % are included and disclosed herein; for example, the amount of ethylene-based polymers in the polymer blend can be from a lower limit of 80, 83, 85, 87, 89, or 90 wt % to an upper limit of 85, 87, 89, 90, 92, 94, 95, 96, 97, 98, 99, 99.5, or 99.9 wt %. For example, the amount of ethylene-based polymers in the polymer blend can be from 80 to 99.99 wt %, or in the alternative, from 85 to 99.9 wt %, or in the alternative, from 85 to 99 wt %, or in the alternative, from 90 to 99 wt%, or in the alternative, from 90 to 95 wt %.

In some embodiments, the polymer blend further comprises at least one polar polymer, polar oligomer, and/or ionomer. The inclusion of such polar polymer, polar oligomer, and/or ionomer in the polymer blend can, in some embodiments, also be useful in stabilizing surface energy, enhancing the print quality of films formed from the polymer blends or having layer comprising the polymer blends, and/or improving the bonding strength of such films to adhesives.

In embodiments of polymer blends where the blend comprises a polar polymer, polar oligomer, and/or ionomer (in addition to the compounds of Formula (I)), the polar polymer, polar oligomer, and/or ionomer can be present in an amount of up to 5 weight percent of the polymer blend based on the total weight of the polymer blend. The polymer blend, in some embodiments, comprises 5% weight percent of the polar polymer(s), polar oligomer(s), and/or ionomer(s) based on the total weight of the polymer blend. The polymer blend, in some embodiments, comprises 3% weight percent of the polar polymer(s), polar oligomer(s), and/or ionomer(s) based on the total weight of the polymer blend.

Non-limiting examples of such polar polymers, polar oligomers, and ionomers include ethylene acrylate copolymer or ionomer thereof, ethylene methyl acrylate copolymer or ionomer thereof, ethylene ethyl acrylate copolymer or ionomer thereof, ethylene butyl acrylate copolymer or ionomer thereof, ethylene acrylic acid copolymer or ionomer thereof, polyethylene glycol, polyethylene-polyethylene glycol, polyethylene- polyethylene glycol-polyethylene, ethylene vinyl acetate copolymer, polyvinyl alcohol, or combinations thereof. Such polar polymers, polar oligomers, and ionomers are commercially available from a variety of sources and persons of skill in the art can be selected appropriate ones based on the teachings herein. Examples of ionomers that can be used in some embodiments include SURLYN® ionomers commercially available from DuPont.

In some embodiments, the polymer blend can further comprise one or more additives known to those of skill in the art including, for example, antioxidants, colorants, slip agents, UV stabilizers, UV absorbers, antiblocks, processing aids, and combinations thereof. In some embodiments, the polymer blend comprises up to 5 weight percent of such additives. All individual values and subranges from 0 to 5 wt % are included and disclosed herein; for example, the total amount of additives in the polymer blend can be from a lower limit of 0.5, 1, 1.5, 2, 2.5, 3, 3.5, 4, or 4.5 wt % to an upper limit of 1, 2, 3, 4, or 5 wt %. In some embodiments, the polymer blend comprises an antioxidant in amount of 0.05 to 1 weight percent, a UV stabilizer in an amount of 0.2 to 2 weight percent, a UV absorber in an amount of 0.2 to 2 weight percent, slip agents in an amount of 0.05 to 1 weight percent, and/or an anti-blocking agent in an amount of 0.05 to 1 weight percent, each based on the total weight of the polymer blend.

Polymer blends of the present invention can be prepared by melt blending the prescribed amounts of the components with a twin screw extruder before feeding into an extruder or other equipment used for film fabrication. Such polymer blends can also be prepared by tumble blending the prescribed amounts of the components before feeding into the extruder or other equipment used for film fabrication. In some embodiments, polymer blends of the present invention can be in the form of pellets. For example, the individual components can be melt blended and then formed into pellets using a twin screw extruder or other techniques known to those of skill in the art based on the teachings herein.

Polymer blends of the present invention can be used to make a number of products including, for example, monolayer films and multilayer films. Thus, some embodiments of the present invention relate to monolayer films comprising any of the polymer blends of the present invention. Some embodiments of the present invention relate to multilayer films comprising any of the polymer blends of the present invention. Such monolayer films and multilayer films may generally be produced using techniques known to those of skill in the art based on the teachings herein.

In some embodiments of multilayer films, an outer layer (i.e., one of the two surface layers) comprises a polymer blend according to any of the embodiments described herein.

An outer surface of a monolayer film comprising the polymer blend, or an outer surface of a multilayer film where an outer layer of the film comprises the polymer blend, is corona treated or plasma treated in order to increase the surface energy of the film using techniques known to those of skill in the art. After such corona treatment or plasma treatment, the outer surface exhibits a surface energy of at least 35, at least 36, or at least 37, or at least 38, or at least 39, or at least 40, or at least 41, or at least 42 or more, dyne/cm as measured by ASTM D 2578-04.

In some embodiments, the outer layer comprising the polymer blend exhibits a surface energy of at least 36 dynes/cm² at 60 days following the corona treatment. In some embodiments, the outer layer of the film comprising the polymer blend is corona treated, and the outer layer exhibits a surface energy of at least 36 dynes/cm² at 150 days following the corona treatment. The surface energy is measured using US ACC dyne pens following ASTM D2578-04a. As set forth elsewhere herein, it is believed that the usage of the inventive polymer blends in the surface layer of a film provides a stable surface energy for an extended period of time so as to avoid the need for a second corona treatment or other action to increase the surface energy.

In a multilayer film, in addition to the outer layer comprising the polymer blend according to embodiments of the present invention, a multilayer film can further comprise other layers typically included in multilayer films. In some embodiments, a multilayer film can comprise 3 or more layers. A multilayer film, in some embodiments, can comprise up to 7 layers in some embodiments. The number of layers in the film can depend on a number of factors including, for example, the desired thickness of the multilayer film, the desired properties of the multilayer film, the intended use of the multilayer film, and other factors. Examples of other types of layers that can be used in various embodiments depending on the intended application include, for example, sealant layers, polyethylene terephthalate layers, oxygen barrier layers, tie layers, polyethylene layers, polypropylene layers, etc. For example, in one embodiment, the multilayer film is a 3-layer film that comprises a first outer layer comprising a polymer blend according to an embodiment of the present invention, a second outer layer that is a sealant layer, and a core layer between the first and second outer layers that comprises a blend of ethylene-based polymers (e.g., a blend of LDPE, LLDPE, and/or HDPE).

In some embodiments, a monolayer film or multilayer film can be oriented either uniaxially or biaxially, depending on the intended use of the film.

Multilayer films may also be used to form laminates according to some embodiments of the present invention. For example, a multilayer film of the present invention can be laminated to a polyethylene terephthalate using an adhesive according to techniques known to those of skill in the art based on the teachings herein.

Embodiments of the present invention also provide packages formed from any of the films described herein. Examples of such packages can include flexible packages, pouches, stand-up pouches, pre-made packages or pouches, protective film, agriculture film, wrapping/stretch film, mulching film, silage film, and adhesive film. Such packages can be formed using techniques known to those of skill in the art in view of the teachings herein.

Some embodiments of polymer blends of the present invention can be used in producing fibers for other applications. Fibers that may be prepared include staple fibers, tow, multi-component, sheath/core, twisted, and monofilament. Suitable fiber forming processes include spin bonded, melt blown techniques, as disclosed in U.S. Pat. Nos. 4,340,563, 4,663,220, 4,668,566, and 4,322,027, gel spun fibers as disclosed in U.S. Pat. No. 4,413,110, woven and nonwoven fabrics, as disclosed in U.S. Pat. No. 3,485,706, or structures made from such fibers, including blends with other fibers, such as polyester, nylon or cotton, thermoformed articles, extruded shapes, including profile extrusions and co-extrusions, calendared articles, and drawn, twisted, or crimped yarns or fibers.

Some embodiments of the invention will now be described in detail in the following Examples.

### EXAMPLES

### Preparation of Compounds of Formula (I)

For use in the following Examples, compounds according to Formula (I) are prepared as described below:

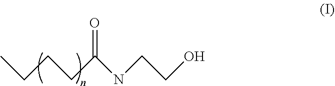

wherein n is 6 to 24.

The starting materials for forming the compounds of Formula (I) are long chain, linear primary carboxylic acids. The materials used are UNICID 350, UNICID 550, and UNICID 700, each commercially available from Baker Hughes Incorporated. These acids have a range of acid numbers and melt points as shown in Table 1:

TABLE 1

| | | Acid Number, |
|---|---|---|
| | Melting | mg KOH/g |
| | Point, ° C. | sample |
| UNIClD acid | (ASTM D-127) | (BWM 3.01 A) |
| UNICID 350 acid | 92 | 120 |
| (“Acid 350”) | | |
| UNICID 550 acid | 101 | 79 |
| (“Acid 550”) | | |
| UNICID 700 acid | 110 | 63 |
| (“Acid 700”) | | |

The UNICID acids are ground to a powder before use.

The mixed fatty acid N-(2-hydroxyethyl) amides are prepared as follows. A solution containing 15 mmol of 2-aminoethanol (available from Sigma-Aldrich with purity 99%) and 20 mmol trimethylamine is prepared in dry THF (50 mL). A solution of 10 mmol acyl chloride in dry THF (50 mL) is added dropwise to the 2-aminoethanol solution under nitrogen. The reaction mixture is stirred for 30 minutes at room temperature, and then the mixture is filtered. The reaction mechanism is:

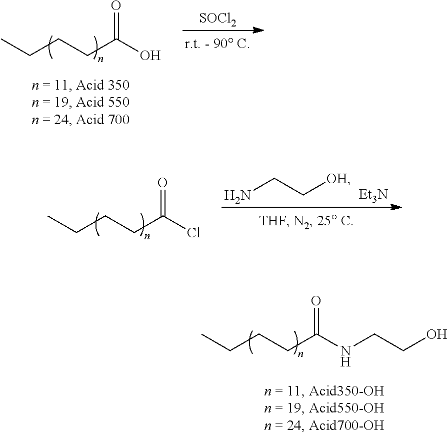

The solid is washed with hexane and diethyl ether and dried in vacuum. The resulting product is recrystallized from CHCl₃/methanol to give pure N-(2-hydroxylethyl) amide as a white solid at a yield of ˜87% or more. Information about the reaction products (each of which being referred to as a “Formula (I) Additive”) is as follows:
N-(2-hydroxyethyl) nonadecanamide (formed from Acid 350, “A350-OH”)
Yield=93%. M.p. 103° C. 1H NMR (400 MHz, CDCl₃): δ 5.87 (1H, s), 3.73 (2H, t, J=5.2 Hz), 3.44 (2H, dd, J=10.0 Hz, 5.0 Hz), 2.21 (2H, t, J=7.5 Hz), 1.66-1.60 (2H, m), 1.25 (s, 30H), 0.88 (3H, t, J=6.5 Hz).
   N-(2-hydroxyethyl) pentacosanamide (formed from Acid 550, “A550-OH”)
Yield=90%. M. p. 104° C. 1H NMR (400 MHz, CDCl₃): δ 5.85 (1H, s), 3.73 (2H, t, J=4.5 Hz), 3.44 (2H, dd, J=10.0 Hz, 5.4 Hz), 2.21 (2H, t, J=7.5 Hz), 1.67-1.61 (2H, m), 1.25 (42H, s), 0.88 (3H, t, J=6.7 Hz).
   N-(2-hydroxyethyl) nonacosanamide (formed from Acid 700, “A700-OH”)
Yield=87%. M.p. 110° C. 1H NMR (400 MHz, CDCl₃): δ 5.71 (1H, s), 3.72 (2H, t, J=5.2 Hz), 3.44 (2H, dd, J=10.0 Hz, 5.2 Hz), 2.20 (2H, t, J=7.5 Hz), 1.65-1.60 (2H, m), 1.25 (50H, s), 0.88 (3H, t, J=6.7 Hz).

### Preparation of Polyethylene Films (“PE Films”)

A linear low density polyethylene (“LLDPE”) (DOWLEX™ 2045 having a density of 0.920 g/cm³ at a melt index (I₂) of 1.0 g/10 minutes) is melt blended with 5% of a Formula (I) Additive at 190° C. for 5 minutes to form a polymer blend according to embodiments of the present invention. The blend is cut into pieces. Additional LLDPE is mixed with the polymer blend pieces to a certain ratio after blending of 1000 ppm, and is heated to 180° C. Blown films are then blown on a HAAKE blown film line utilizing a 1 mm die gap. The extruder temperature profile is 180-210° C. with an L/D ratio of 25. The output is 5 kg/h. Separate films are formed using each of the Formula (I) Additives. Each PE Film has a nominal thickness of 50 microns. A comparative film (Comparative Film 1 or “Com.-1”) is formed in the same way except without any Formula (I) Additive.

The films are then corona treated using a Suman corona treater to a surface energy of 40 dynes/cm² as set out in Table 2. Surface energies (dynes) are detected using US ACC dyne pens.

TABLE 2

| | | | Corona Method |
|---|---|---|---|
| | | | for reaching |
| | | Initial | 40 Dynes/cm² |
| | | Surface | (output voltage/ |
| | Additives, | Energy | times of |
| Film | 1000 ppm | (Dynes/cm²) | back and forth) |
| Comp. Film 1 | None | 30-32 | 30 v/0.5 |
| (“Com.-1”) | | | |
| Inventive Film 1 | A350-OH | 30 | 30 v/0.5 |
| (“Inv.-1”) | | | |
| Inventive Film 2 | A550-OH | 30 | 30 v/0.5 |
| (“Inv.-2”) | | | |
| Inventive Film 3 | A700-OH | 30 | 30 v/0.5 |
| (“Inv.-3”) | | | |

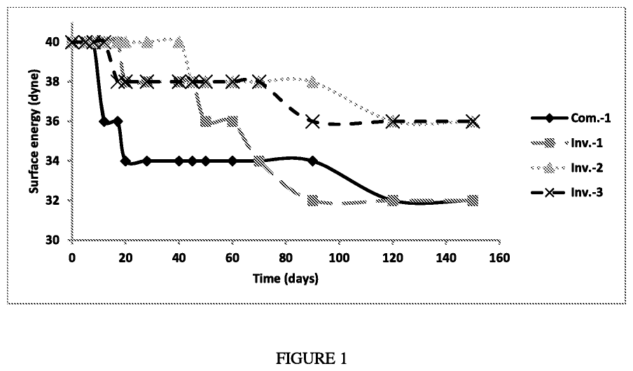

The surface energy of each PE Film is then measured regularly over a period over 150 days to determine how well the film surface retains surface energy. The results are shown in FIG. 1.

For Inventive Films 1-3, 1000 ppm of an N-(2-hydroxyethyl) amide having different alkyl chain lengths (compounds of Formula (I) with n=11 (A350-OH), n=19 (A550-OH), and n=24 (A700-OH)) stabilize the surface energy of the PE Film (>36 dynes/cm²) after corona treatment in 60 days as compared with Comparative Film 1 without any Formula (I) Additives. For Inventive Film 2, the Formula (I) Additive (n=11) stabilized the surface energy of the PE Film (>38 dyne/cm2) after corona treatment in 90 days. For Inventive Films 2 and 3, the Formula (I) Additive (n=11 for Inventive Film 2 and n=13 for Inventive Film 3) stabilized the surface energy of the PE Film (>36 dyne/cm²) after corona treatment in 150 days.

### Preparation of PE-PET Laminates

A laminate is formed from Comparative Film 1 and Inventive Film 1. The PE Film is laminated with a 12 micron polyethylene terephthalate film (“PET Film”) using a Jintu HR380 hot roller at 80° C. Before lamination, the outer surface of the PE Film to be laminated to the PET Film is corona treated at 150V. 2 g/m² dry weight of a polyacrylate adhesive (Robond™ 168/CR-3A) is coated on PET Film surface for laminating to the PE Film. After lamination, the films are put into oven at 50 or 60° C., for 60 hours for aging.

The bonding strengths of the PET Film to the PE Film are measured using the peeling test of EN ISO 11339:2005. The results are shown in Table 3:

TABLE 3

| | Formula | | PE Film/ |
|---|---|---|---|
| | (I) | Corona | PET Film |
| | Additive, | Treatment before | Opening Force |
| Laminate | 1000 ppm | Lamination | (N/mm) |
| Comp. Laminate | None | 150 V (>42 dynes) | 0.0570 |
| Inventive | A550-OH | 150 V (>42 dynes) | Could not open |
| Laminate | | | unless broken |

As shown with the Inventive Laminate, 1000 ppm of the Formula (I) Additive (A550-OH having n=11) has a positive effect on adhesive lamination of the PE Film to the PET Film in comparison with Comparative Film 1.

As shown in these Examples as compared to a PE Film without the Formula (I) Additive, the inclusion of Formula (I) Additives in polyethylene films can effectively stabilize the surface energy of the polyethylene films for an extended period of time after corona treatment. The Formula (I) Additives can also have a good anchoring interaction for polyethylene films which can help enhance the bonding strength of the polyethylene film to an adhesive.

1. A polymer blend comprising:
an ethylene-based polymer; and
one or more compounds of Formula (I): 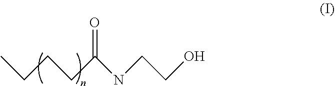
wherein n is 6 to 24.

2. The polymer blend of claim 1, wherein the blend comprises 0.01 to 5 weight percent of compounds of Formula (I).

3. The polymer blend of claim 1 further comprising at least one polar polymer, polar oligomer, or ionomer wherein the polar polymer, polar oligomer, or ionomer comprises ethylene acrylate copolymer or ionomer thereof, ethylene methyl acrylate copolymer or ionomer thereof, ethylene ethyl acrylate copolymer or ionomer thereof, ethylene butyl acrylate copolymer or ionomer thereof, ethylene acrylic acid copolymer or ionomer thereof, polyethylene glycol, polyethylene-polyethylene glycol, polyethylene-polyethylene glycol-polyethylene, ethylene vinyl acetate copolymer, polyvinyl alcohol, or combinations thereof.

4. The polymer blend of claim 3, wherein the polymer blend comprises 5 weight percent or less of polar polymer or polar oligomer based on the total weight of the polymer blend.

5. The polymer blend of claim 1, wherein the blend comprises a first compound of Formula (I) and a second compound of Formula (I), wherein the value of n for the second compound is different from the value of n for the first compound.

6. A film comprising a layer comprising the polymer blend of claim 1.

7. The film of claim 6, wherein the film is a multilayer film comprising an outer layer and wherein the outer layer comprises the polymer blend.

8. The film of claim 7, wherein the outer layer of the film comprising the polymer blend is corona treated, wherein the outer surface exhibits a surface energy of at least 36 dynes/cm² at 60 days following the corona treatment.

9. A package formed from a film according to claim 6.

10. A fiber comprising the polymer blend of claim 1.
